(19) United States
(12) Patent Application Publication
(10) Pub. No.: US 2008/0102938 A1
(43) Pub. Date: May 1, 2008

(54) PERIPHERAL DEVICE OF GAMING MACHINE, SERVER, AND GAME SYSTEM

(75) Inventor: Jun Fujimoto, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: ARUZE CORP., Tokyo (JP)

(21) Appl. No.: 11/853,081

(22) Filed: Sep. 11, 2007

(30) Foreign Application Priority Data
Sep. 12, 2006 (JP) 2006-247248

(51) Int. Cl. A63F 13/00

(52) U.S. Cl. 463/25; 463/29; 463/42

(57) ABSTRACT

A peripheral device of a gaming machine includes an imaging unit, a memory, and a processor. The memory stores therein a reference data item of a predetermined area of an image that is based on an imaging signal generated by the imaging unit. The memory further stores therein several imaging signals generated by the imaging unit under several different imaging conditions. The processor operates to select, among the imaging signals stored in the memory, such an imaging signal that a data item about an image based thereon is closest to the reference data item of the predetermined area of the image. The processor further operates to set a condition for an imaging by the imaging unit to an imaging condition corresponding to the imaging signal thus selected.

### CROSS REFERENCE TO RELATED APPLICATION

This application is based upon and claims the benefit of priority from the prior Japanese Patent Application No. 2006-247248, filed on Sep. 12, 2006, the entire contents of which are incorporated herein by reference.

### BACKGROUND OF THE INVENTION

1. Field of the Invention

The present invention relates to a peripheral device of a gaming machine such as a pachinko gaming machine, a pachi-slot gaming machine and the like, to a server connected to the peripheral device, and also to a game system including the peripheral device and the server.

2. Description of Related Art

A game medium lending device is provided in relation to a gaming machine such as a pachinko gaming machine, a pachi-slot gaming machine, a slot machine and the like. Upon receiving a lendout command, the game medium lending device lends a game medium, such as a gaming ball, a coin and the like, based on a credit. More specifically, the game medium lending device discharges a game medium from the game medium lending device, or commands a gaming machine to discharge a game medium. For example, when cash is inserted into the game medium lending device, an amount equivalent to the cash is stored as a credit in the game medium lending device. Instead of cash, there may be used a card such as a prepaid card, a member card and the like in which a credit reserved by previous insertion of cash is stored. When the card is inserted, the game medium lending device reads out the credit from the card and lends a game medium based on the credit. At this time, the game medium lending device communicates with a management server of a game arcade and performs an authentication.

In a case where a card is used in reservation and/or readout of a credit as described above, someone may take a card out of a game medium lending device for evil practice while a user is temporarily leaving the game medium lending device for some reason. Since a device that supports a card use includes a card conveyor, a card reader and the like, a malfunction such as a card jam, a readout error and the like is likely to occur.

In a game arcade, a casino, or the like, there are devices, such as the game medium lending device, that handle cash and/or a game medium of the same value as cash. Some of the devices adopt a fingerprint authentication system for authenticating an operator such as a staff (see Japanese Unexamined Patent Publication No. 2000-61124, Japanese Unexamined Patent Publication No. 2002-126177, and Japanese Unexamined Patent Publication No. 2002-8131). The fingerprint authentication system is easy to adopt because a fingerprint authentication mechanism such as an imaging mechanism is relatively small, but it involves a problem that an authentication is undesirably given even when a true operator is forced to image his/her fingerprint by someone. Considering the above, it is preferable to adopt a face authentication system (see Japanese Unexamined Patent Publication No. 2005-202731). A face authentication is system gives recognition of being imaged, not only to an authenticatee but also to people surrounding the authenticatee.

### SUMMARY OF THE INVENTION

In a fingerprint authentication, there is little environmental influence on accuracy of an imaged picture because an imaging object is relatively small. In a face authentication, however, there is great environmental influence on accuracy of an imaged picture because an imaging object is relatively large.

In a game arcade, effect illumination using a cocktail light and the like is performed, and many players are moving to find preferable machines. In addition, influence of an outdoor light differs depending on a distance from an entrance/exit. Thus, the surrounding environment rapidly changes. Therefore, a good face image may not be obtained in a game arcade. Moreover, a posture of an imaged person, for example, a player, largely affects accuracy of a face image. For example, if an imaged person sits on a chair with a small backrest, sits leaning forward, or sits leaning back, a good face image can not be obtained. Like this, it is not easy to obtain a good face image in a game arcade. This may cause an improper situation that a player is not authenticated though he/she is actually an authenticatable person. If a threshold value for authentication is lowered for the purpose of avoiding such an improper situation, it becomes more likely that an actually unauthenticatable person is authenticated.

In order to perform a highly accurate face authentication, it is important that an imaging condition for a camera as an imaging unit is properly set prior to an imaging operation in such a manner that an imaging object can properly be imaged.

An object of the present invention is to provide a peripheral device of a gaming machine, a server, and a game system that realize a highly accurate face authentication.

According to a first aspect of the present invention, there is provided a peripheral device of a gaming machine. The peripheral device comprises an imaging unit, a memory, and a processor. The imaging unit images a human face and generates an imaging signal. The memory stores therein a reference data item relating to at least one of a hue, a brightness, and a chroma of a predetermined area of an image that is based on the imaging signal generated by the imaging unit. The memory further stores therein a plurality of imaging signals generated by the imaging unit under a plurality of different imaging conditions. The processor operates to select, among the imaging signals stored in the memory, such an imaging signal that a data item about an image based thereon is closest to the reference data item with respect to at least one of a hue, a brightness, and a chroma of the predetermined area of the image. The processor further operates to set a condition for an imaging by the imaging unit to an imaging condition corresponding to the imaging signal thus selected.

According to a second aspect of the present invention, there is provided a server connected to a peripheral device of a gaming machine. The peripheral device has an imaging unit, a first memory, and a first processor. The imaging unit images a human face and generates an imaging signal. The first memory stores therein a reference data item relating to at least one of a hue, a brightness, and a chroma of a predetermined area of an image that is based on the imaging signal generated by the imaging unit. The first memory further stores therein a plurality of imaging signals generated by the imaging unit under a plurality of different imaging conditions. The first processor operates to select, among the imaging signals stored in the first memory, such an imaging signal that a data item about an image based thereon is closest to the reference data item with respect to at least one of a hue, a brightness, and a chroma of the predetermined area of the image. The first processor further operates to set a condition for an imaging by the imaging unit to an imaging condition corresponding to the imaging signal thus selected. The server comprises a second processor and a second memory. The second processor operates to receive, from the peripheral device, either one of an imaging signal generated by the imager and a data item obtained by conversion from the imaging signal. The second memory stores therein either one of the signal and the data item received by the second processor. The second processor further operates to perform an authentication based on whether one that agrees with either one of the signal and the data item thus received is stored in the second memory or not.

According to a third aspect of the present invention, there is provided a game system comprising a peripheral device of a gaming machine and a server connected to the peripheral device. The peripheral device has an imaging unit, a first memory, and a first processor. The imaging unit images a human face and generates an imaging signal. The first memory stores therein a reference data item relating to at least one of a hue, a brightness, and a chroma of a predetermined area of an image that is based on the imaging signal generated by the imaging unit. The first memory further stores therein a plurality of imaging signals generated by the imaging unit under a plurality of different imaging conditions. The first processor operates to select, among the imaging signals stored in the first memory, such an imaging signal that a data item about an image based thereon is closest to the reference data item with respect to at least one of a hue, a brightness, and a chroma of the predetermined area of the image. The first processor further operates to set a condition for an imaging by the imaging unit to an imaging condition corresponding to the imaging signal thus selected. The server has a second processor and a second memory. The second processor operates to receive, from the peripheral device, either one of an imaging signal generated by the imaging unit and a data item obtained by conversion from the imaging signal. The second memory stores therein either one of the signal and the data item received by the second processor. The second processor further operates to perform an authentication based on whether one that agrees with either one of the signal and the data item thus received is stored in the second memory or not.

In the first to third aspects, the processor of the peripheral device operates to select one of the plurality of imaging signals based on the reference data. The processor of the peripheral device further operates to set an imaging condition for the imaging unit to an imaging condition corresponding to the imaging signal thus selected. The imaging unit performs an imaging under the imaging condition thus set. This realizes a highly accurate face authentication.

### BRIEF DESCRIPTION OF THE DRAWINGS

Other and further objects, features and advantages of the invention will appear more fully from the following description taken in connection with the accompanying drawings in which:

FIG. 1 is a block diagram showing a game system according to an embodiment of the present invention;

FIG. 2 is a perspective view showing an appearance of a game medium lending device;

FIG. 3 is a block diagram showing an electrical construction of the game medium lending device;

FIG. 4 is a structural diagram showing an interior of a CCD camera;

FIG. 5 is a block diagram showing an electrical construction of a server;

FIG. 6 is an explanatory view showing a construction of a face image data base;

FIG. 7 is a block diagram showing an electrical construction of a credit refund device;

FIG. 8 is a flowchart showing a processing executed by the game medium lending device;

FIG. 9 is a flowchart showing a credit reservation processing executed by the game medium lending device;

FIG. 10 is a flowchart showing an imaging condition setting processing;

FIG. 11 is a flowchart showing a credit reservation processing executed by the server;

FIG. 12 is a flowchart showing a credit readout processing executed by the game medium lending device;

FIG. 13 is a flowchart showing a credit readout processing executed by the server;

FIG. 14 is a flowchart showing a processing that is executed by the game medium lending device when a notification of unusability is received from the server;

FIG. 15 is a flowchart showing a processing that is executed by the credit refund device in refunding a credit;

FIG. 16 is a flowchart showing a processing that is executed by the server in refunding a credit; and

FIG. 17 is a flowchart showing an arrangement processing for a face image data base that is executed by the server.

### DESCRIPTION OF THE PREFERRED EMBODIMENTS

In the following, a certain preferred embodiment of the present invention will be described with reference to the accompanying drawings.

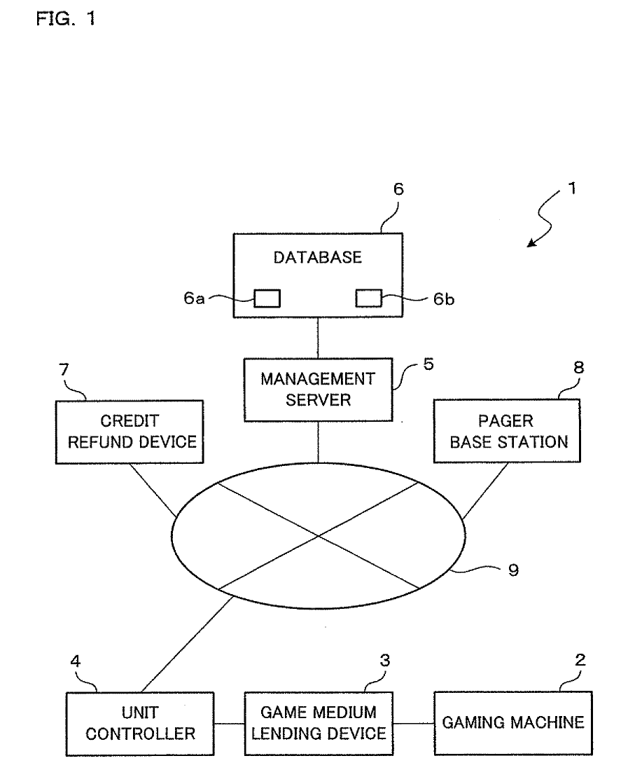

FIG. 1 is a block diagram showing a game system according to an embodiment of the present invention. A game system 1 according to this embodiment is adopted in one game arcade, and includes gaming machines 2 (only one of which is shown in FIG. 1), game medium lending devices 3 provided beside the respective gaming machines 2, a unit controller 4, a management server 5, a database 6, a credit refund device 7, and a pager base station 8. In the game arcade, many game units each made up of a pair of the gaming machine 2 and the game medium lending device 3 are disposed. The game medium lending device 3 and the credit refund device 7 are peripheral devices of the gaming machine 2.

Hereinafter, a description will be given on an assumption that the gaming machine 2 is a pachinko gaming machine. A game medium lending device 3 is disposed on a right side of a corresponding gaming machine 2 when seen from a user side of the gaming machine 2. Upon receiving a command to lend out a gaming ball, the game medium lending device 3 lends out a gaming ball based on a credit stored therein.

The unit controller 4, which is shared among game units placed in the game arcade, relays communication between the server 5 and the respective game units. The respective game units may directly communicate with the server 5 without interposition of the unit controller 4.

The server 5 manages information regarding the game medium lending devices 3 and the gaming machines 2 placed in the game arcade, and the like. In addition, the server makes a check in a face authentication. The database 6 is connected to the server 5. The database 6 is made up of a hard disk for example, and includes a face image database 6a and a game medium lending device database 6b. The server 5 may be placed either inside or outside the game arcade. It may be possible that the server 5 is provided not only for one game arcade but also several game arcades in common.

Upon receiving a command to refund a credit, the credit refund device 7 refunds cash that is equivalent to a credit stored in the server 5. The credit refund device 7 is placed in the game arcade, and more specifically in a premium exchange section or near an entrance/exit of the game arcade for example.

The pager base station 8 is a base station that communicates with a pager (not shown) carried by a staff of the game arcade. The pager base station 8 is placed in the game arcade.

A game arcade network 9 is used for communication between the server 5, which is placed outside the game arcade such as in a control room, and the gaming machines 2, the game medium lending devices 3, the unit controller 4, the credit refund device 7, and the pager base station 8 which is placed inside the game arcade. The communication may be done through a special line instead of the game arcade network 9.

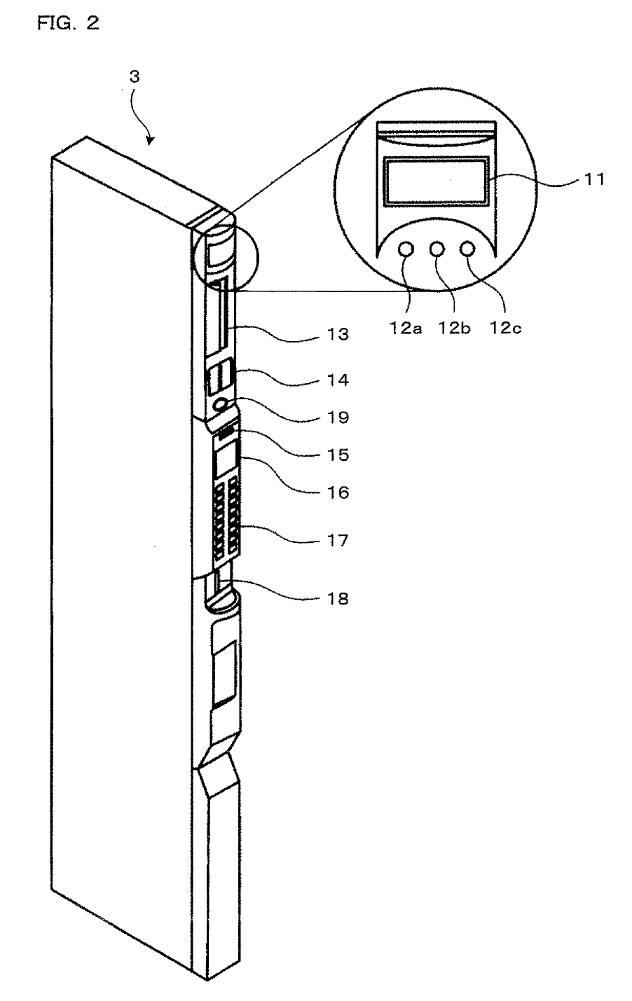

FIG. 2 is a perspective view showing an appearance of the game medium lending device 3. The game medium lending device 3 has, on its front face, a warning lamp 11, three state indicator LEDs 12a, 12b, and 12c, a bill insertion slot 13, a coin insertion slot 14, a remote control communication window 15, a display LCD 16, a ten-key pad 17, a coin return opening 18, and a CCD camera window 19. These components are visible to a user.

The warning lamp 11 issues a warning by lighting and flashing, when a malfunction, such as an error in a face authentication which will be described later, occurs in the game medium lending device 3.

Each of the state indicator LEDs 12a to 12c lights and/or flashes. A state of the game medium lending device 3 or the gaming machine 2 corresponding to the game medium lending device 3 is indicated by means of a combination of lighting and/or flashing of the respective state indicator LEDs 12a to 12c. The state indicator LEDs 12a to 12c indicate, for example, a face imaging wait state, a data readout state, and the like.

A bill is inserted into the bill insertion slot 13. A coin is inserted into the coin insertion slot 14. When an improper coin is inserted into the coin insertion slot 14, the improper coin is discharged from the coin return opening 18. An acceptable denomination may be limited to a bill. In such a case, the coin insertion slot 14 and the coin return opening 18 are omitted.

The remote control communication window 15 captures a remote control signal by infrared light or the like which is transmitted from a remote control transmitter (not shown) carried by a staff. The remote control transmitter transmits a command to the game medium lending device 3.

The display LCD 16 displays thereon information received from the server 5 or generated by the game medium lending device 3, and the like. The display LCD 16 and the ten-key pad 17 form a control panel that is operated by a user.

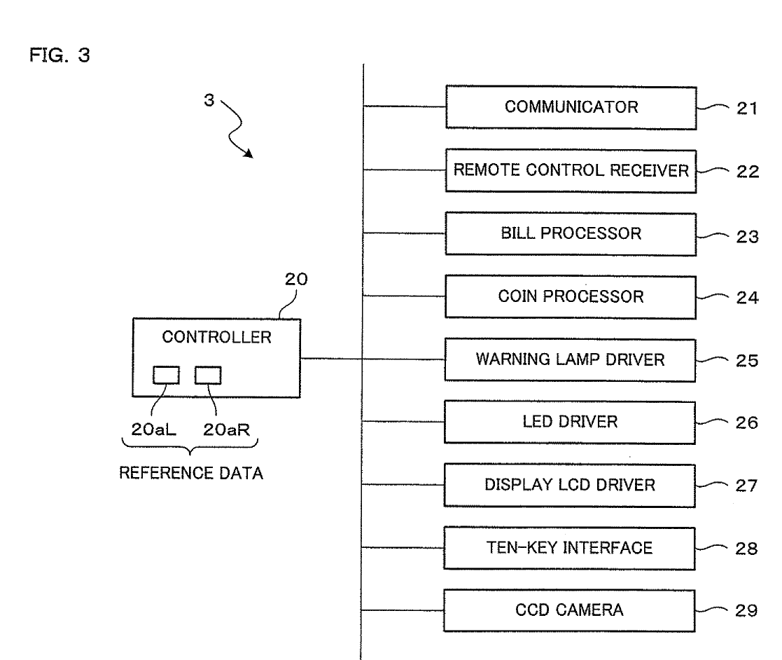

A CCD camera 29 (see FIG. 3) that performs an imaging through the CCD camera window 19 for a face authentication is provided behind the CCD camera window 19. The window 19 may be formed of a transparent flat plate or a hemispherical plate. Here, the window 19 may swing integrally with the CCD camera 29, as will be described later.

FIG. 3 is a block diagram showing an electrical construction of the game medium lending device 3. The game medium lending device 3 includes a controller 20, a communicator 21, a remote control receiver 22, a bill processor 23, a coin processor 24, a warning lamp driver 25, an LED driver 26, a display LCD driver 27, a ten-key interface 28, and a CCD camera 29.

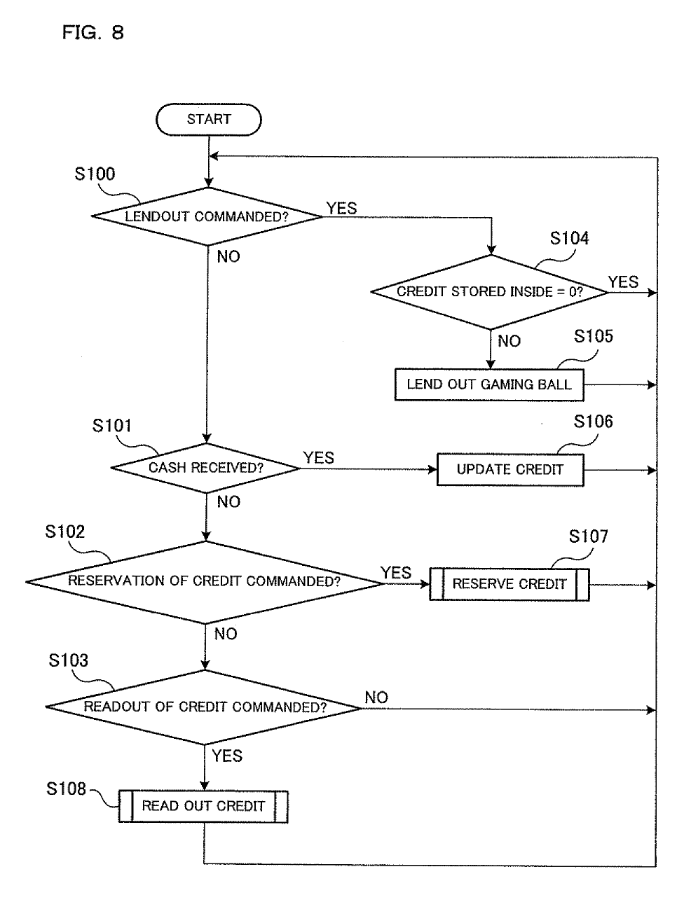

The controller 20 commands a general control over the game medium lending device 3, and includes a CPU, ROM, and RAM. The controller 20 controls the respective parts of the game medium lending device 3 so as to make the game medium lending device 3 execute processings shown by flowcharts of FIGS. 8, 9, 10, 12, and 14 which will be described later. The controller 20 stores therein data necessary for a control, including a credit.

The controller 20 converts a right imaging signal and a left imaging signal into right-side face image data and left-side face image data, respectively. The right imaging signal is transmitted from the CCD camera 29 of the game medium lending device 3. The left imaging signal is transmitted from a CCD camera 29 of a game medium lending device 3 corresponding to a gaming machine 2 that is, when seen from a user side, left adjacent to the aforesaid gaming machine 2 corresponding to the aforesaid game medium lending device 3. Hereinafter, the game medium lending device 3 corresponding to the gaming machine 2 left adjacent to the aforesaid gaming machine 2 will be referred to as a “left-side game medium lending device”, and the CCD camera 29 of the left-side game medium lending device 3 will be referred to as a “left-side CCD camera”. Also, the right-side face image data and the left-side face image data will sometimes be generally referred to as “face image data”. The right imaging signal and the left imaging signal are signals after an analog-digital conversion.

Thus, in this embodiment, a pair of left and right face image data is used for a face authentication. In a case where there is no game medium lending device 3 on a left side of the gaming machine 2 corresponding to the game medium lending device 3 when seen from a user of the gaming machine 2, for example, a thin-type imaging-purpose device having only an imaging function is placed instead of the game medium lending device 3. The game medium lending device 3 communicates through the unit controller with the left-side game medium lending device 3 or the imaging-purpose device.

The controller 20 stores therein a pair of reference data 20aL and 20aR. The reference data 20aL and 20aR are set by a staff of a maker or a game arcade at a time when, for example, the left-side game medium lending device 3 and the game medium lending device 3 are placed. Thereafter, the reference data 20aL and 20aR are maintained. For example, a staff sits on a chair that is provided in front of the gaming machine 2 corresponding to the game medium lending device 3, and an imaging is performed by the left-side CCD camera 29 and the CCD camera 29 using a portable lighting device under a predetermined lighting condition irrespective of a location of the gaming machine 2. Then, the left-side CCD camera 29 and the CCD camera 29 generate a left imaging signal and a right imaging signal, respectively. Data corresponding to a predetermined area, which is designated by the staff, of an image based on the left imaging signal and the right imaging signal are set as the reference data 20aL and 20aR. For example, in a case where the image based on the left and right imaging signals pictures therein a machine number provided at an upper part of a gamine machine 2 that is disposed in opposition to the game medium lending device 3 and the left-side game medium lending device 3, data corresponding to an area of the image containing the machine number are set as the reference data 20aL and 20aR.

For setting the reference data 20aL and 20aR, the game medium lending device 3 has a connector that allows communication with a terminal (not shown) having a monitor. Communication between the game medium lending device 3 and the terminal may be done through the communicator 21.

Even under the predetermined lighting condition, an image obtained may vary depending on a time range. Accordingly, it may be possible to set different reference data 20aL and 20aR for every time range. Alternatively, it may be possible that the controller 20 executes a statistical processing for each of the left imaging signal and the right imaging signal from the left-side CCD camera 29 and the CCD camera 29, and a left imaging signal and a right imaging signal averaged in a predetermined period of time by the statistical processing are set as the reference data 20aL and 20aR.

Under control by the controller 20, the communicator 21 communicates with the gaming machine 2 corresponding to the game medium lending device 3, the unit controller 4, and the server 5. The game medium lending device 3 may be provided with separate communicates for communicating with the corresponding gaming machine 2 and for communicating with the unit controller 4 and the server 5.

Under control by the controller 20, the remote control receiver 22 receives a remote control signal and transmits the remote control signal to the controller 20, through the remote control communication window 15.

Under control by the controller 20, the bill processor 23 controls a bill conveyor, a bill recognizer, a bill storage (all not shown), and the like. The bill processor 23 thereby validates a bill and determines a denomination, and transmits information about the bill to the controller 20. When the bill processor 23 determines that a bill inserted into the bill insertion slot 13 is a false bill, the bill processor 23 makes the bill discharged from the bill insertion slot 13.

Under control by the controller 20, the coin processor 24 controls a coin conveyor, a coin recognizer, a coin storage (all not shown), and the like. The coin processor 24 thereby validates a coin and determines a denomination, and transmits information about the coin to the controller 20. When the coin processor 24 determines that a coin inserted into the coin insertion slot 14 is a false coin, the coin processor 24 makes the coin discharged from the coin return opening 18. A coin usable in the game medium lending device 3 may be limited to 500 yen coins. This makes it easy to validate a coin and determine a denomination.

Under control by the controller 20, the warning lamp driver 25 drives the warning lamp 11. Under control by the controller 20, the LED driver 26 drives the state indicator LEDs 12a to 12c.

Under control by the controller 20, the display LCD driver 27 drives the display LCD 16. For example, a credit, a message, and other data are displayed on the display LCD 16. Under control by the controller 20, the ten-key interface 28 senses an operation made on the ten-key pad 17 by a user, and transmits to the controller 20 a signal regarding the operation.

Under control by the controller 20, the CCD camera 29 images a face of a user using the gaming machine 2 through the CCD camera window 19. The CCD camera 29 generates an imaging signal and transmits the imaging signal to the controller 20.

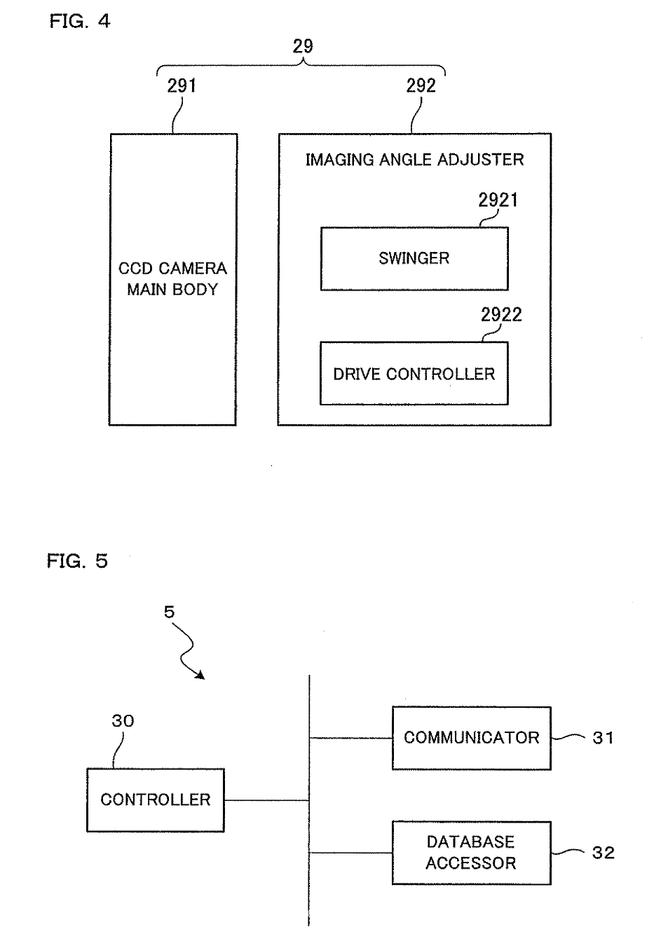

FIG. 4 is a structural diagram showing an interior of the CCD camera 29. The CCD camera 29 includes a CCD camera main body 291 and an imaging angle adjuster 292. For example, a monochrome CCD camera or a color CCD camera is adopted as the main body 291. The imaging angle adjuster 292 has a swinger 2921 and a drive controller 2922. The swinger 2921 swings the main body 291 left and right. The drive controller 2922 commands the swinger 2921 to swing.

FIG. 5 is a block diagram showing an electrical construction of the server 5. The server 5 includes a controller 30, a communicator 31, and a database accessor 32.

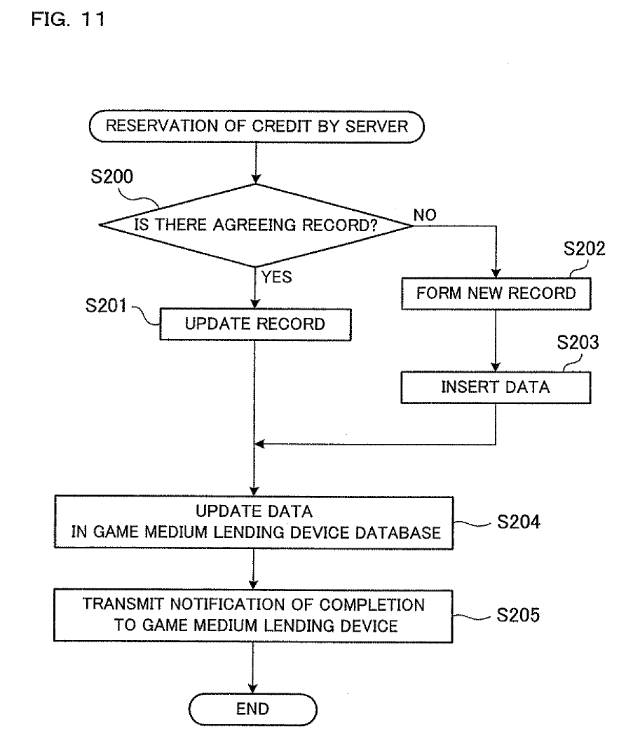

The controller 30 commands a general control over the server 5r and includes a CPU, a ROM, and a RAM. The controller 30 controls the respective parts of the server 5 so as to make the server 5 execute processings shown by flowcharts of FIGS. 11, 13, 16, and 17 which will be described later. The controller 30 stores therein data necessary for a control.

Under control by the controller 30, the communicator 31 communicates with the game medium lending devices 3, the gaming machines 2, the unit controller 4, the credit refund device 7, and the pager base station 8. The communicator 31 adopts a polling method in which the communicator 31 sequentially communicates with the game medium lending devices 3 and the credit refund device 7. The server 5 may have several communicators that are selectively used in accordance with the respective communicates such as the game medium lending devices 3, the gaming machines 2, the unit controller 4, the credit refund device 7, and the pager base station 8.

Under control by the controller 30, the database accessor 32 accesses the database 6, and writes in or reads out data.

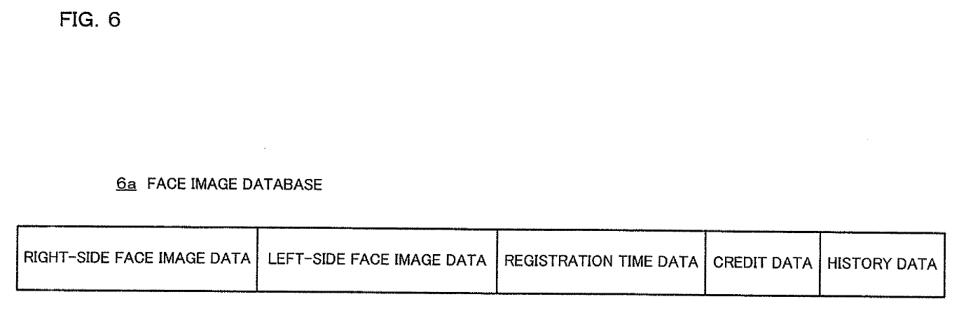

FIG. 6 is an explanatory view showing a construction of the face image data base 6a included in the database 6. One record of the face image database Ga includes a right-side face image data field, a left-side face image data field, a registration time data filed, a credit data field, and a history data field.

Right-side face image data are data of an image obtained by any game medium lending device 3 imaging a face of a user using a gaming machine 2 corresponding to the game medium lending device 3, or data obtained by processing the data of the image. Left-side face image data are data of an image obtained by the left-side game medium lending device 3 imaging a face of a user using the aforesaid gaming machine 2, or data obtained by processing the data of the image.

Each record of the face image database 6a is sorted in accordance with a string of “0” and “1” from a head of the right-side face image data.

Registration time data are data regarding time and date at which the record was formed. In this embodiment, refund of a credit is allowed only within a date on which the credit is stored in the server 5, that is, only within a registration date. Whether a credit can be refunded or not is determined based on the registration time data. Alternatively, it may be possible that refund of a credit is allowed only for a predetermined period such as one month after the registration date.

Regarding history data, when data including face image data are received from any game medium lending device 3, data except the face image data are stored together with a reception time.

The game medium lending device database 6b, a construction of which is not shown, stores therein various data for each game medium lending device 3 such as data of a credit stored inside the game medium lending device 3, data of a time at which the credit is stored in the game medium lending device 3, data about whether the gaming machine 2 corresponding to the game medium lending device 3 is now in game or not, and the like. Face image data are not stored in the game medium lending device database 6b.

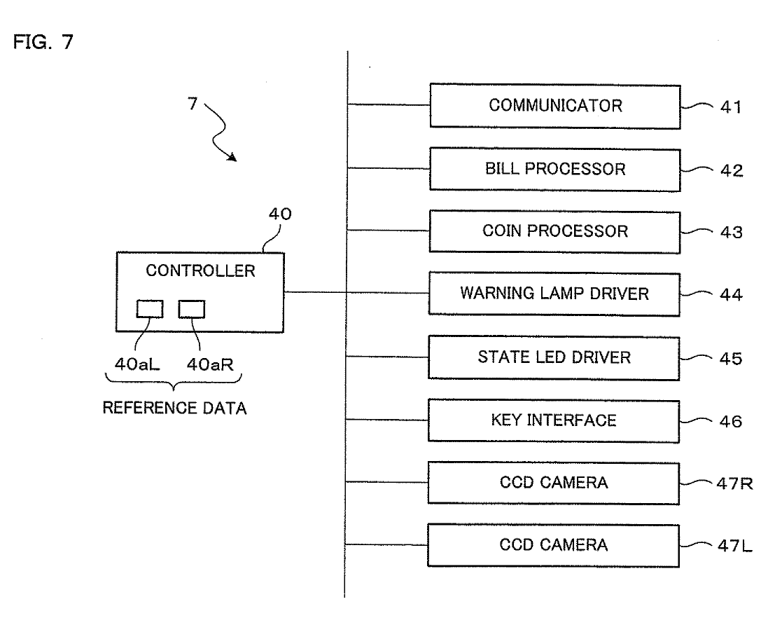

FIG. 7 is a block diagram showing an electrical construction of the credit refund device 7. The credit refund device 7 includes a controller 40, a communicator 41, a bill processor 42, a coin processor 43, a warning lamp driver 44, a state LED driver 45, a key interface 46, and a pair of CCD cameras 47L and 47R.

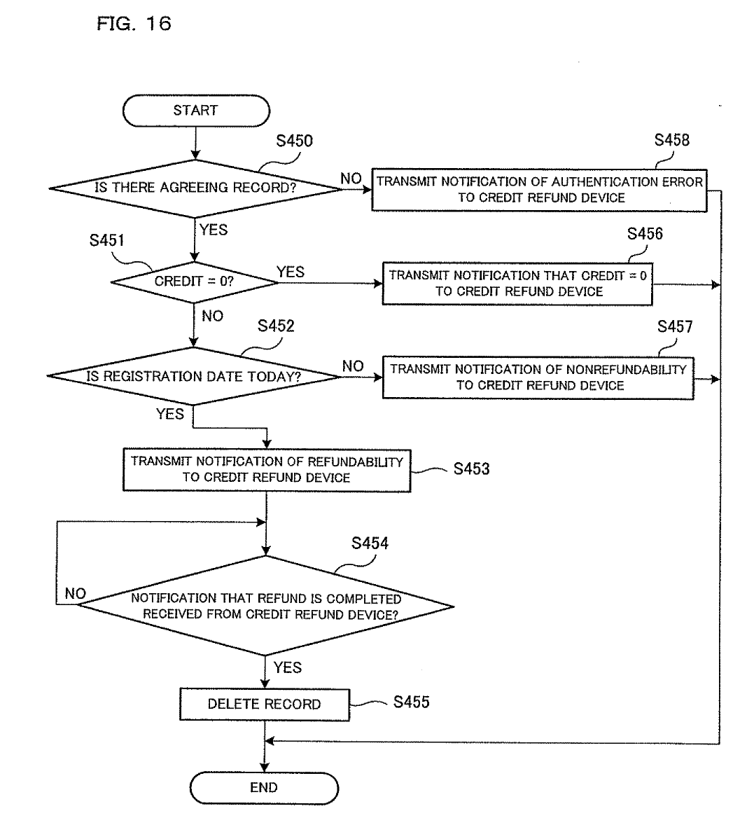

The controller 40 commands a general control over the credit refund device 7, and includes a CPU, a ROM, and a RAM. The controller 40 controls the respective parts of the credit refund device 7 so as to make the credit refund device 7 execute processings shown by a flowchart of FIG. 16 which will be described later. The controller 40 stores therein data necessary for a control.

The controller 40 converts a left imaging signal and a right imaging signal transmitted from the CCD cameras 47L and 47R, into left-side face image data and right-side face image data, respectively. The controller 40 stores therein a pair of reference data 40aL and 40aR. Like the reference data 20aL and 20aR, the reference data 40aL and 40aR are set by a staff of a maker or a game arcade at a time when, for example, the credit refund device 7 is placed. Thereafter, the reference data 40aL and 40aR are maintained. How to set the reference data 40aL and 40aR may be the same as how to set the reference data 20aL and 20aR.

Under control by the controller 40, the communicator 41 communicates with the server 5. The credit refund device 7 may be outside a polling conducted by the server 5.

Under control by the controller 40, the bill processor 42 controls a bill conveyor, a bill storage (both not shown), and the like. Thereby, when bill discharge is needed in refunding a credit, an instructed number of bills of instructed kind are discharged from a bill discharge opening (not shown).

Under control by the controller 40, the coin processor 43 controls a coin conveyor, a coin storage (both not shown), and the like. Thereby, when coin discharge is needed in refunding a credit, an instructed number of coins of instructed kind are discharged from a coin discharge opening (not shown).

Under control by the controller 40, the warning lamp driver 44 drives a warning lamp (not shown).

Under control by the controller 40, the state LED driver 45 drives one or more state LEDs (not shown). By means of lighting or flashing of the state LEDs, or a combination of lighting and/or flashing of the state LEDs, a user of the credit refund device 7 is recommended to sit in an imaging position, that is, on a chair (not shown) provided in front of the credit refund device 7. The key interface 46 senses an operation made on a refund key, a staff calling key (both not shown), or the like by a user, and transmits to the controller 40 a signal regarding the operation.

Under control by the controller 40, the CCD cameras 47L and 47R image a face of a user sitting on the chair to generate an imaging signal, and transmit the imaging signal to the controller 40. A positional relationship between the chair provided in front of the credit refund device 7 and the CCD camera 47R is the same as a positional relationship between a chair provided in front of a gaming machine 2 and a CCD camera 29 of a game medium lending device 3 that corresponds to the gaming machine 2. A positional relationship between the chair provided in front of the credit refund device 7 and the CCD camera 47L is the same as a positional relationship between a chair provided in front of a gaming machine 2 and a CCD camera 29 of a game medium lending device 3 that is left adjacent to the gaming machine 2. Unlike the CCD camera 29 of the game medium lending device 3, the CCD cameras 47L and 47R of the credit refund device 7 may not include a swinger.

Since constructions of the gaming machine 2, the unit controller 4, and the pager base station 8 are common ones, descriptions thereof will be omitted.

Next, a processing executed by the game system 1 will be described. In this embodiment, a face authentication is used in reserving a credit, reading out a credit, and refunding a credit. Here, it should be noted that, since a face image is private information, a registration of a face image is performed only in reserving a credit and any unnecessary registration is not performed.

In the game system 1, a player firstly inserts cash into the game medium lending device 3 corresponding to the gaming machine 2, and thereby obtains a credit equivalent to an amount of the cash. Then, the player obtains gaming balls using a part or all of the credit, and plays a game in the gaming machine 2 using the gaming balls. At an end of the game, a credit left in the game medium lending device 3 which means a credit unused for a lendout of gaming balls is reserved in the server 5. Then, when the player plays a game in another gaming machine 2, the player commands, in a game medium lending device 3 corresponding to the gaming machine 2, a readout of the credit from the server 5. Thereby, the player obtains gaming balls using the credit previously left, and plays a game in the another gaming machine 2.

FIG. 8 is a flowchart showing a processing executed by the game medium lending device 3.

The controller 20 of the game medium lending device 3 firstly determines whether a lendout of gaming balls has been commanded or not (S100). When a lend key provided on the game media lending device 3 or a lend key provided on the gaming machine 2 corresponding to the game media lending device 3 is operated, the controller 20 determines that a lendout of gaming balls has been commanded (S100: YES) and determines whether a credit stored inside is 0 or not (S104). When the credit is 0 (S104: YES), the processing is returned to S100. When the credit is not 0 (S104: NO), gaming balls are lent out (S105) and then the processing is returned to S100.

In S105, the controller 20 commands a gaming ball discharger (not shown), which is included in the gaming machine 2 corresponding to the game medium lending device 3, to discharge a predetermined number of gaming balls. The discharged gaming balls are received by a gaming ball receiver of the gaming machine 2. Then, the controller 20 reduces the credit stored inside, by one unit. The controller 20 updates a display of the credit made by the display LCD 16, and notifies the server 5 that the credit has been updated. When the server 5 receives from the game medium lending device 3 a notification that the credit has been updated, the server 5 updates a credit of the game medium lending device 3 stored in the game medium lending device database 6b.

Data transmission from each game medium lending device 3 to the server 5 is performed at a timing when the server 5 grants, by a polling, the game medium lending device 3 a right of transmission.

When the controller 20 determines that a lendout of gaming balls has not been commanded (S100: NO), then the controller 20 determines whether cash has been received or not (S101). When there is a notification of cash reception from the bill processor 23 and/or coin processor 24, the controller 20 determines that cash has been received (S101: YES) and updates a credit (S16). Then, the processing is returned to S100.

In S106, the controller 20 increases a credit stored inside by an amount equivalent to the cash received. The controller 20 updates a display of the credit made by the display LCD 16, and notifies the server 5 that the credit has been updated. When the server 5 receives from the game medium lending device 3 a notification that the credit has been updated, the server 5 updates a credit of the game medium lending device 3 stored in the game medium lending device database 6b.

When the controller 20 determines that cash has not been received (S101: NO), then the controller 20 determines whether a reservation of a credit has been commanded or not (S102). When a credit reservation key provided on the game media lending device 3 or a credit reservation key provided on the gaming machine 2 corresponding to the game media lending device 3 is operated, the controller 20 determines that a reservation of a credit has been commanded (S102: YES) and reserves a credit (S107). Then, the processing is returned to S100.

Processing in steps S107 and S108 are not executed in a case where a user of the gaming machine 2 corresponding to the game medium lending device 3 is executing another processing such as a game.

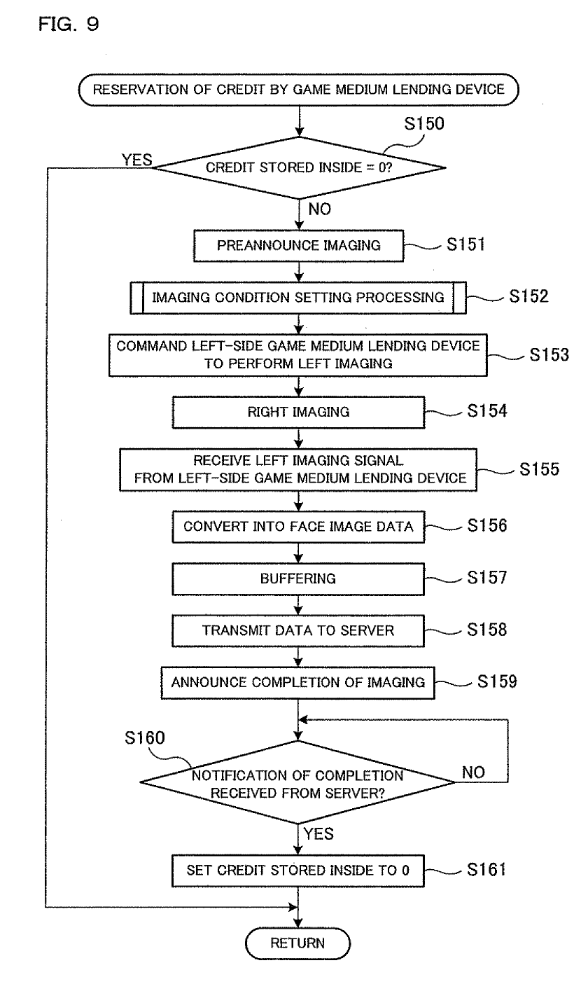

Here, the processing executed in S107 will be described with reference to FIG. 9. The controller 20 firstly determines whether a credit stored inside is 0 or not (S150). When a credit is 0 (S150: YES), the processing ends.

When a credit is not 0 (S150: NO), the controller 20 preannounces an imaging, that is, announces to a user of the corresponding gaming machine 2 that an imaging will be performed soon, by means of a combination of lighting and/or flashing of the state indicator LEDs 12a to 12c, and/or by means of a message on the display LCD 16 (S151). Here, the combination of lighting and/or flashing includes lighting or flashing of only one of the state indicator LEDs 12a to 12c, which applies to following descriptions, too. Then, the controller 20 sets an imaging condition for the CCD camera 29 of the game medium lending device 3 and the left-side CCD camera 29 of the left-side game medium lending device 3 (S152).

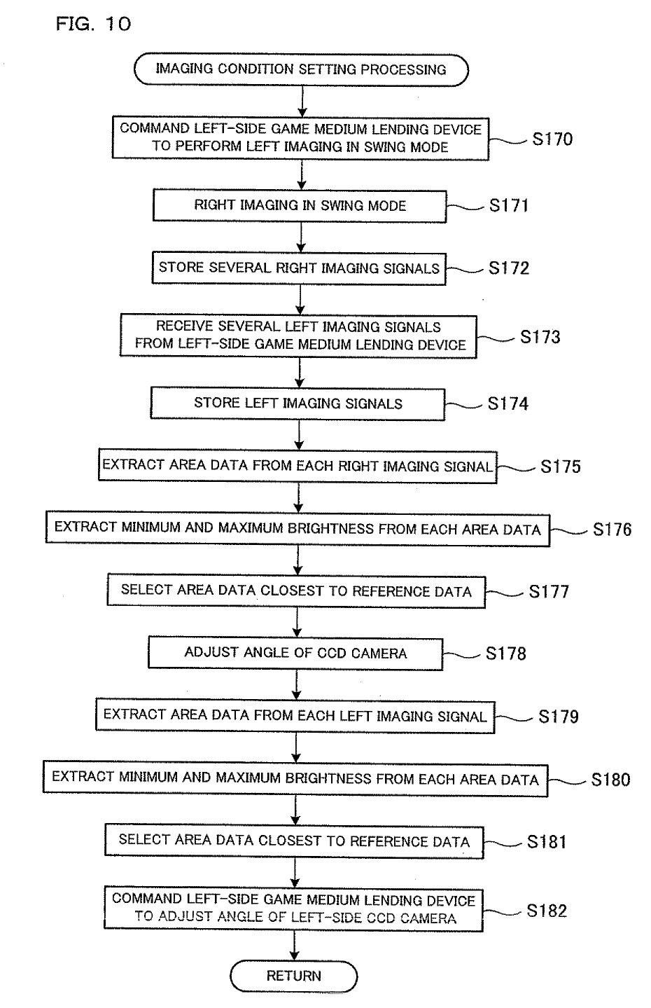

FIG. 10 is a flowchart showing an imaging condition setting processing S152.

During a waiting time, the main body 291 of the CCD camera 29 is oriented in such a direction as to image a face of a user of the gaming machine 2 corresponding to the game medium lending device 3, that is, in such a direction as to perform a right imaging which will be described later.

The controller 20 firstly commands a controller 20 of a left-side game medium lending device 3 to perform a left imaging in a swing mode (S170). The left imaging means that a CCD camera 29 of a game medium lending device 3 images a face of a user using a gaming machine 2 that is, when seen from a user using a gaming machine 2 corresponding to this game medium lending device 3, right adjacent to this game medium lending device 3. The imaging in a swing mode means that an imaging is performed while a main body 291 of a CCD camera 29 is swinging about a direction toward a predetermined reference point (hereinafter referred to as a reference direction) left and right within a predetermined angle range. The CCD camera 29 performs imagings at different angles with respect to the reference direction, and generates imaging signals corresponding to the respective angles. In this embodiment, the reference point is a position of a face of a user to be imaged.

The controller 20 of the left-side game medium lending device 3, which has received a command mentioned above, controls the swinger 2921 so as to orient the main body 291 of the leftside CCD camera 29 toward the reference point, that is, toward a face of a user using the gaming machine 2 that is right adjacent when seen from a user using the gaming machine 2 corresponding to this game medium lending device 3.

After S170, the controller 20 controls the CCD camera 29 so as to perform a right imaging in the swing mode (S171). The right imaging means that a CCD camera 29 of a game medium lending device 3 images a face of a user using a gaming machine 2 that corresponds to this game medium lending device 3. Like the left-side CCD camera 29, the CCD camera 29 performs imagings at different angles with respect to the reference direction, and generates imaging signals corresponding to the respective angles.

Then, the controller 20 stores therein the right imaging signals generated by the CCD camera 29 of the game medium lending device 3, in association with the corresponding imaging angles, respectively (S172). The controller 20 receives the left imaging signals generated by the left-side CCD camera 29 from the controller 20 of the left-side game medium lending device 3 (S173), and stores therein the left imaging signals in association with the corresponding imaging angles, respectively (S174).

Then, the controller 20 extracts, from each of the right imaging signals, data corresponding to an area that is substantially identical to the area designated at a time when the reference data 20aR were set. In other words, the controller 20 extracts area data from each of the right imaging signals (S175). To be more specific, an image based on the right imaging signal is divided by 1 to 5 pixels with respect to each of a horizontal direction and a vertical direction, and a sum of squared differences between a pixel value of each division and a pixel value of the reference data 20aR is calculated. Data corresponding to a division in which the sum of squared differences is smallest are set as the area data.

Next, the controller 20 extracts a minimum brightness and a maximum brightness from each area data (S176). The minimum brightness and the maximum brightness thus extracted from each area data are compared with a minimum brightness and a maximum brightness included in the reference data 20aR, and one of the area data closest to the reference data 20aR are selected (S177). The minimum brightness and the maximum brightness included in the reference data 20aR may be extracted in a processing of S177, or may be stored in the controller 20 at the time when the reference data 20aR were set.

Calculated in S177 are a difference between the minimum brightness included in each area data and the minimum brightness included in the reference data 20aR, and a difference between the maximum brightness included in the area data and the maximum brightness included in the reference data 20aR, for example. These differences are summed, and area data in which the sum is smallest are selected as the one closest to the reference data 20aR.

After S177, the controller 20 extracts an imaging angle stored in association with the right imaging signal from which the area data selected in S177 are derived. Then, the controller 20 controls the swinger 2921 to adjust an angle of the main body 291 of the CCD camera 29 so that an imaging is performed at the angle (S178).

Then, like in S175, the controller 20 extracts, from each of the left imaging signals, data corresponding to an area that is substantially identical to the area designated at a time when the reference data 20aL were set. In other words, the controller 20 extracts area data from each of the left imaging signals (S179). Then, like in S176, the controller 20 extracts a minimum brightness and a maximum brightness from each area data (S180). Then, like in S177, the controller 20 selects one of the area data closest to the reference data 20aL (S181). The controller 20 extracts an imaging angle stored in association with the left imaging signal from which the area data selected in S181 are derived. Then, the controller 20 commands the controller 20 of the left-side game medium lending device 3 to control the swinger 2921 of the left-side CCD camera 29 to adjust an angle of the main body 291 (S182).

Referring to FIG. 9 again, after S152, the controller 20 gives a left imaging command including imaging time data, to the controller 20 of the left-side game medium lending device 3 (S153).

The controller 20 of the left-side game medium lending device 3, which has received the command, sends back a signal indicating that a left imaging can be performed to the commander game medium lending device 3, in a case where the left imaging can be performed. Then, the controller 20 of the left-side game medium lending device 3 makes a control in such a manner that the left-side CCD camera 29 performs a left imaging at a time corresponding to the imaging time data. Then, the controller 20 of the left-side game medium lending device 3 transmits a left imaging signal thus generated to the commander game medium lending device 3. In case where a left imaging cannot be performed because the left-side CCD camera 29 is preparing for a right imaging or performing a right imaging for example, the controller 20 of the left-side game medium lending device 3 does not send back the signal indicating that a left imaging can be performed, and does not perform a left imaging.

Then, the controller 20 controls the CCD camera 29 so as to perform a right imaging at a time corresponding to the imaging time data, only when the signal indicating that a left imaging can be performed is received from the controller 20 of the left-side game medium lending device 3 (S154). When the signal indicating that a left imaging can be performed is not received from the controller 20 of the left-side game medium lending device 3, the controller 20 repeatedly gives the above-described command to the controller 20 of the left-side game medium lending device 3. After S154, the controller 20 receives the left imaging signal transmitted from the controller 20 of the left-side game medium lending device 3 (S155).

Subsequently, by an arbitrary method, the controller 20 converts the right imaging signal generated by the right imaging in S154 and the left imaging signal received in S155 into right-side face image data and left-side face image data, respectively (S156). Then, the controller 20 buffers the face image data (S157).

In a case where an imaging goes wrong, where area data are not extracted in S175 and S179, and the like, an announcement of a reimaging is made through the state indicator LEDs 12a to 12c and/or the display LCD 16, and an imaging is performed again.

After S157, at a timing when a right of transmission is granted, the controller 20 transmits to the server 5 a command to reserve a credit together with the credit data stored inside, the face image data, and an ID of the game medium lending device 3 (S158). Then, through the state indicator LEDs 12a to 12c and/or the display LCD 16, the controller 20 announces that an imaging is completed (S159).

The server 5 receives the data transmitted from the game medium lending device 3 in S158, and then executes a processing shown in FIG. 11.

The controller 30 of the server 5 firstly determines whether there is a record including face image data that agree with the received face image data in the face image database 5a, or not (S200). When there is the record in the face image database 6a (S200: YES), the controller 30 updates the record (S201). To be more specific, the controller 30 updates credit data included in the record so as to increase an original value by an amount of the credit received. In addition, the controller 30 adds data concerning a current data reception into the history data field. When there is not a record including face image data that agree with the received face image data in the face image database 6a (S200: NO), the controller 30 forms a new record (S202). Then, the controller 30 inserts the received face image data into a face image data field of the new record, a data reception time measured by a timer that is built in the controller 30 into a registration time data field of the new record, the received credit data into a credit data field of the new record, and data concerning the current data reception into a history data field of the new record (S203). The new record is sorted in accordance with the face image data.

Here, a procedure of determination of “agreement” will be described. A threshold may be used for determination of agreement. For example, it may be possible to determine a degree of agreement only for right-side face image data, and omit calculation of a degree of agreement for left-side face image data when the degree of agreement is equal to or greater than a first threshold, thus determining that agreement occurs. This shortens a time required for determination. Alternatively, it may be possible to calculate a degree of agreement for left-side face image data when the degree of agreement for right-side face image data is smaller than a first threshold and equal to or greater than a second threshold, and determine agreement based on an average degree of agreement for the left and right face image data. When the degree of agreement for right-side face image data is smaller than the second threshold, it may be determined that agreement does not occur.

After S201 or S203, the controller 30 updates data in the game medium lending device database 6b (S204). Here, in the game medium lending device database 6b, a credit corresponding to the data transmitter game medium lending device 3 is set to 0. Then, by a polling, the controller 30 transmits a notification that a reservation is completed, to the data transmitter game medium lending device 3 (S205).

Referring to FIG. 9 again, when a notification of completion is received from the server 5 (S160: YES), the controller 20 of the game medium lending machine 3 sets the credit data stored inside to 0 (S161). At this time, a display of the credit by the display LCD 16 is turned to 0. Thus, the reservation processing of S107 is completed, and the processing is returned to S100 of FIG. 8.

Referring to FIG. 8 again, when the controller 20 determines that a reservation of a credit has not been commanded (S102: NO), the controller 20 determines whether a readout of a credit has been commanded or not (S103). When a readout key provided on the game media lending device 3 or a readout key provided on the gaming machine 2 corresponding to the game media lending device 3 is operated, the controller 20 determines that a readout of a credit has been commanded (S103: YES) and reads out a credit (S108). Then, the processing is returned to S100.

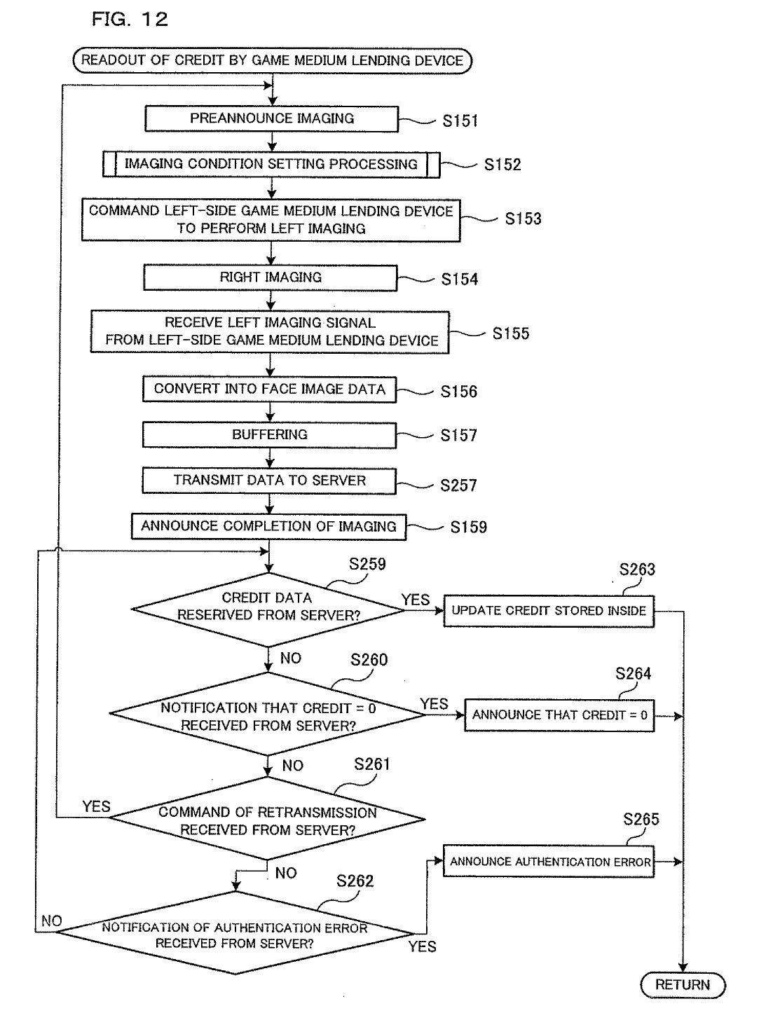

Here, a processing executed in S108 will be described with reference to FIG. 12. The same steps as the steps shown in FIG. 9 will be denoted by the same reference numerals, and specific descriptions thereof will be omitted.

The controller 20 firstly executes steps S151 to S157 which are the same as shown in FIG. 9. After S157, at a timing when a right of transmission is granted, the controller 20 transmits to the server 5 a command to read out a credit together with the face image data and an ID of the game medium lending device 3 (S257). Then, through the state indicator LEDs 12a to 12c and/or the display LCD 16, the controller 20 announces that an imaging is completed (S159).

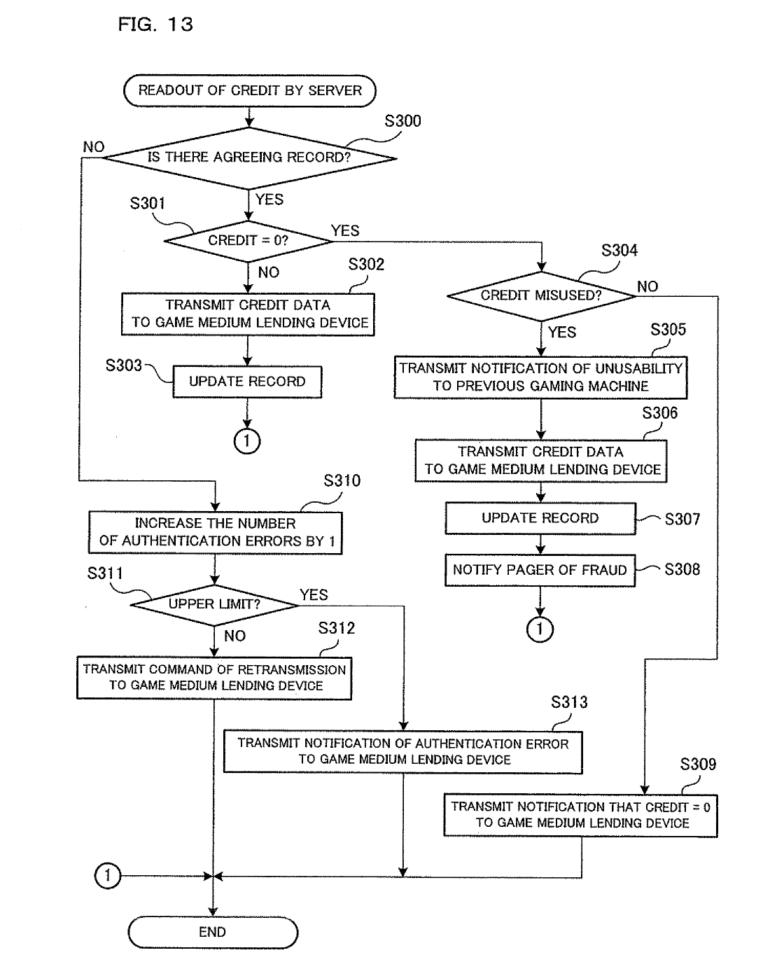

The server 5 receives the data transmitted from the game medium lending device 3 in S257, and then executes a processing shown in FIG. 13.

The controller 30 of the server 5 firstly determines whether there is a record including face image data that agree with the received face image data in the face image database 6a, or not (S300). This step is the same as the step S200 described above, and a determination of agreement is also the same as described above.

When there is the record in the face image database 6a (S300: YES), the controller 30 determines whether credit data included in the record are 0 or not (S301). When credit data are not 0 (S301: NO), the controller 30 transmits the credit data included in the record to the game medium lending device 3 (S302). Then, the controller 30 updates the record (S303). More specifically, the controller 30 sets the credit data included in the record to 0, and further adds current contents to a history data field. In addition, the controller 30 updates a credit of the game medium lending device 3 in the game medium lending device database 6b.

When the credit data are 0 (S301: YES), the controller 30 identifies a gaming machine 2 most previously used by the user and a time of the use, based on history data. Thus, the controller 30 determines whether there is a possibility of misuse of a credit that is actually possessed by the user (S304).

For example, after playing a game in a certain gaming machine 2, a user may move to another gaming machine 2 without reserving his/her credit in the server 5 by means of a game medium lending device 3 corresponding to the certain gaming machine 2, that is, with his/her credit being left in the game medium lending device 3. In such a case, a next user who uses the certain gaming machine 2 may play a game using the credit left by the previous user. Like this, a credit actually possessed by a user may be misused. Therefore, the controller 30 determines that there is a possibility of misuse when, based on memory contents of the face image database 6a and the game medium lending device database 6b, a game medium lending device 3 corresponding to the most previously used gaming machine 2 did not receive cash during a period of time from the time of the use to the current readout command but nevertheless holds credit data other than 0.

When there is a possibility of misuse (S304: YES), the controller 30 transmits a notification of unusability to the most previously used gaming machine 2 (S305). Then, the controller 30 transmits credit data concerning the game medium lending device 3 corresponding to the most previously used gaming machine 2, which are stored in the game medium lending device database 6b, to the data transmitter game medium lending device 3 (S306). Then, like in S303, the controller 30 updates the record (S307). Then, the controller 30 notifies a pager carried by a staff who covers the most previously used gaming machine 2, that there is a possibility of fraud (S308).

Here, it is preferable that the credit data transmitted in S306 and S302 contain information that enable one to be distinguished from the other.

When the credit data are 0 (S301: YES) and there is no possibility of misuse ($304: NO), the controller 30 transmits a notification that a credit is 0 to the data transmitter game medium lending device 3 (S309).

When there is not a record including face image data that agree with the received face image data in the face image database 6a (S300: NO), the controller 30 adds 1 to the number of authentication errors in the data transmitter game medium lending device 3 (S310), and determines whether the number of authentication errors has reached an upper limit, for example 3, or not (S311). When the number has not reached an upper limit (S311: NO), the controller 30 transmits to the game medium lending device 3 a command to retransmit face image data (S312). When the number has reached an upper limit (S311: YES), the controller 30 transmits a notification of an authentication error to the game medium lending device 3 (S313).

Referring to FIG. 12 again, after S159, the controller 20 of the game medium lending device 3 determines whether credit data have been received from the server 5 or not (S259). When credit data have been received (S259: YES), the controller 20 updates a credit stored inside (S263). More specifically, the controller 20 increases a credit stored inside by an amount of credit data received, and updates a display of the credit made by the display LCD 16. Then, the controller 20 ends a readout processing of S108, and the processing is returned to S100 of FIG. 8.

Reception of credit data transmitted from the server 5 in S306 and reception of credit data transmitted from the server 5 in S302 may be distinguished from each other by a combination of lighting and/or flashing of the state indicator LEDs 12a to 12c.

When credit data have not been received (S259: NO), the controller 20 determines whether a notification that a credit is 0 is received from the server 5 or not (S260). When the notification has been received (S260: YES), the controller 20 announces that a credit is 0 by means of the display LCD 16 and/or the state indicator LEDs 12a to 12c (S264). Then, the controller 20 ends a readout processing of S108, and the processing is returned to S100 of FIG. 8.

When the notification that a credit is 0 has not been received (S260: NO), the controller 20 determines whether a command of retransmission has been received from the server 5 or not (S261). When the command is received (S261: YES), the controller 20 returns the processing to S151.

When the command of retransmission is not received (S261: NO), the controller 20 determines whether a notification of an authentication error has been received from the server 5, or not (S262). When the notification has been received (S262: YES), the controller 20 announces an authentication error by means of the display LCD 16 and/or the state indicator LEDs 12a to 12c (S265). Then, the controller 20 ends a readout processing of S108, and the processing is returned to S100 of FIG. 8. When the notification has not been received (S262: NO), the controller 20 returns the processing to S259.

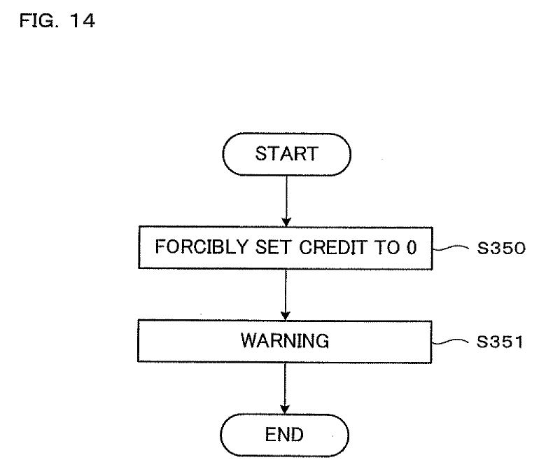

FIG. 14 is a flowchart showing a processing that is executed by the game medium lending device 3 when a notification of unusability is received from the server 5 (see S305 of FIG. 13).

Upon receiving a notification of unusability from the server 5, the controller 20 of the game medium lending device 3 forcibly sets a credit stored inside to 0 (S350). At this time, a display of the credit by the display LCD 16 is turned to 0. The controller 20 issues a warning by lighting or flashing the warning lamp 11, or using a buzzer (S351).

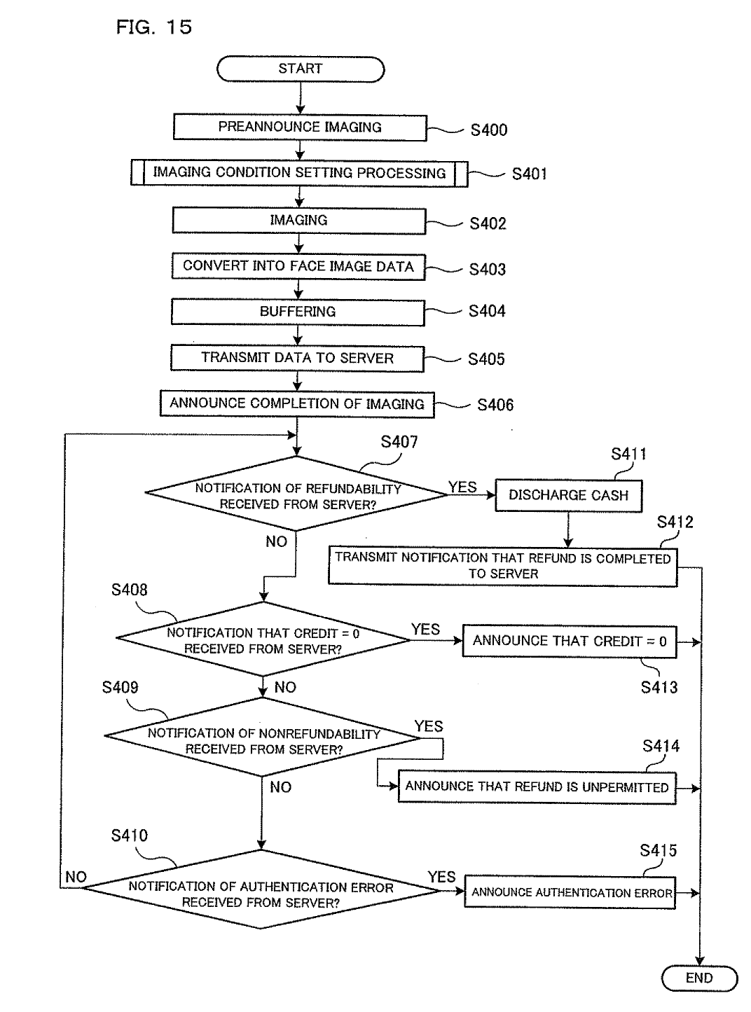

FIG. 15 is a flowchart showing a processing that is executed by the credit refund device 7 when a credit is refunded. A credit reserved in the server 5 is refunded in the form of cash. No particular limitation may be put on when to refund the credit. However, in this embodiment, a date of refund of the credit is limited to a date on which the credit is stored in the server 5, that is, limited to a registration date.

The controller 40 of the credit refund device 7 awaits an operation of the refund key or the staff calling key. When the refund key is operated, the controller 40 executes a processing shown in FIG. 15. A user sits on a chair provided in front of the credit refund device 7, and operates the refund key or the staff calling key. A description of a processing that is executed when the staff calling key is operated will be omitted.

When the refund key is operated, the controller 40 firstly preannounces an imaging, that is, announces to a user of the credit refund device 7 that an imaging will be performed soon, by means of a combination of lighting and/or flashing of the state indicator LEDs (not shown), and/or by means of a message on a display LCD in a case where the credit refund device 7 includes a display LCD (S400). Then, the controller 40 sets an imaging condition for the CCD cameras 47L and 47R (S401). A processing in S401 is the same as the imaging condition setting processing S152 which has been described above with reference to FIG. 10, and therefore a specific description thereof will be omitted.

After S401, the controller 40 makes a control in such a manner that the CCD cameras 47L and 47R perform an imaging at a predetermined time (S402).

Then, the controller 40 converts a left imaging signal generated by the CCD camera 47L and a right imaging signal generated by the CCD camera 47R into face image data, respectively (S403). Then, the controller 40 buffers the face image data (S404).

After S404, at a timing when a right of transmission is granted, the controller 40 transmits to the server 5 a command to refund a credit together with the face image data and an ID of the credit refund device 7 (S405). Then, through the state indicator LEDs and/or the display LCD, the controller 40 announces that an imaging is completed (S406).

The server 5 receives the data transmitted from the credit refund device 7 in S405, and then executes a processing shown in FIG. 16.

The controller 30 of the server 5 firstly determines whether there is a record including face image data that agree with the received face image data in the face image database 6a, or not (S450).

When there is the record in the face image database 6a (S450: YES), the controller 30 determines whether credit data included in the record are 0 or not (S451). When the credit data are not 0 (S451: NO), the controller 30 refers registration time data for this record, to determine whether a registration date is today or not (S452). When a registration date is today (S452: YES), the controller 30 transmits to the credit refund device 7 a notification of refundability together with the credit data in this record (S453). Then, upon receiving a notification that a refund is completed from the credit refund device 7 (S454: YES), the record is deleted (S455) and the processing shown in FIG. 16 ends.

When the credit data are 0 (S451: YES), the controller 30 transmits a notification that a credit is 0 to the credit refund device 7 (S456).

When the credit data are not 0 (S451: NO) and in addition a registration date is not today (S452: NO), the controller 30 transmits a notification of nonrefundability to the credit refund device 7 (S457). The notification of nonrefundability notifies that although a credit is not 0 a refund of the credit is unpermitted because its registration date is not today.

When there is not a record including face image data that agree with the received face image data in the face image database 6a (S450: NO), the controller 30 transmits a notification of an authentication error to the credit refund device 7 (S458).

Referring to FIG. 15 again, after S406, the controller 40 of the credit refund device 7 determines whether a notification of refundability has been received from the server 5 or not (S407). When a notification of refundability has been received (S407: YES), the controller 40 controls the bill processor 42 and/or coin processor 43 so as to discharge cash an amount of which corresponds to the credit data received together with the notification (S411). Then, the controller 40 transmits a notification that a refund is completed to the server 5 (S412), and ends the processing shown in FIG. 15.

When a notification of refundability has not been received (S407: NO), the controller 40 determines whether a notification that a credit is 0 has been received from the server 5 or not (S408). When a notification that a credit is 0 has been received (S408: YES), the controller 40 announces that a credit is 0 by means of a not-shown display LCD and/or not-shown state indicator LEDs (S413). Then, the controller 40 ends the processing shown in FIG. 15.

When a notification that a credit is 0 has not been received (S408: NO), the controller 40 determines whether a notification of nonrefundability has been received from the server 5 or not (S409). When a notification of nonrefundability has been received (S409: YES), the controller 40 announces, for a predetermined period of time such as approximately 5 seconds, that a refund of a credit is permitted only on a registration date by means of a not-shown display LCD and/or not-shown state indicator LEDs (S414). Then, the controller 40 ends the processing shown in FIG. 15.

When a notification of nonrefundability has not been received (S409: NO), the controller 40 determines whether a notification of an authentication error has been received from the server 5 or not (S410). When a notification of an authentication error has been received (S410: YES), the controller 40 announces an authentication error for a predetermined period of time such as approximately 5 seconds by means of the not-shown display LCD and/or the not-shown state indicator LEDs (S415). Then, the controller 40 ends the processing shown in FIG. 15.

It may be possible that, when there is an authentication error (S450: NO), the controller 30 of the server 5 counts the number of authentication errors and transmits a command of retransmission to the credit refund device 7 as in S310 of FIG. 13.

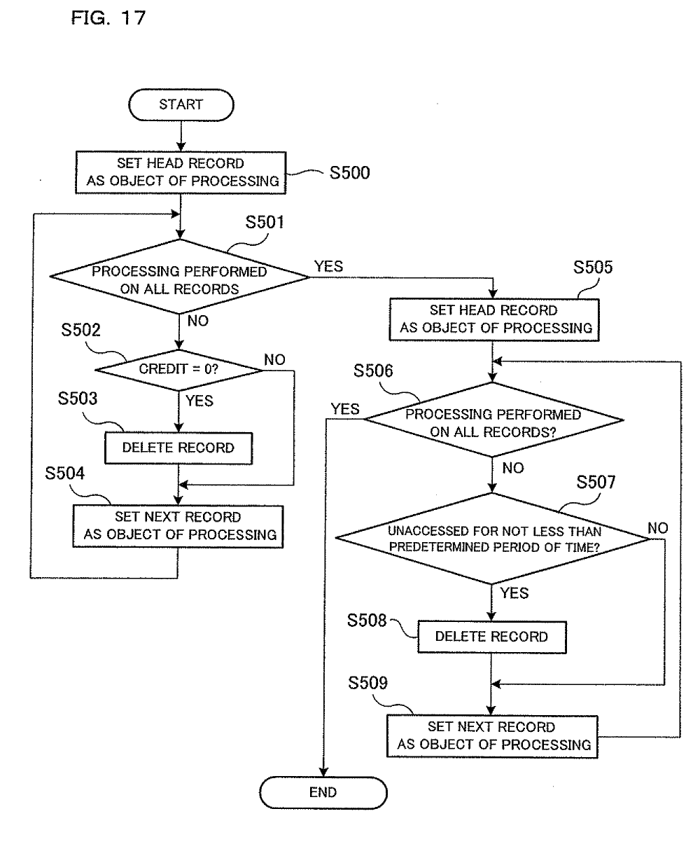

FIG. 17 is a flowchart showing an arrangement processing for a face image data base 6a that is executed by the controller 30 of the server 5.

When a predetermined time comes after business hours of the game arcade, for example, at eleven p.m., the controller 30 automatically executes a processing shown in FIG. 17. In a case where the server 5 is provided with a man-machine interface such as a ten-key pad, a remote control receiver or the like, it may be possible that the server 5 executes the processing shown in FIG. 17 in accordance with a command from a manager or a staff of the game arcade.

The controller 30 firstly sets a head record to be an object of a first processing (S500). Then, the controller 30 determines whether the first processing has been performed on all records or not (S501). When the first processing has not been performed on all records (S501: NO), the controller determines whether a credit in a record to be subjected to the first processing is 0 or not (S502). When the credit is 0 (S502: YES), the record is deleted (S503). Then, the controller 30 sets a next record to be an object of the first processing (S504), and the processing returns to S501. When the credit in the record to be subjected to the first processing is not 0 (S502: NO), the processing proceeds to S504 with skipping the step S503, that is, without deleting the record.

When the first processing has been performed on all records (S501: YES), the controller 30 sets a head record, which means a head record among record left after the first processing, to be an object of a second processing (S505). Then, the controller 30 determines whether the second processing has been performed on all records or not (S506). When the second processing has not been performed on all records (S506: NO), the controller 30 refers to registration time data and history data in a record to be subjected to the second processing, to determine whether the record has been unaccessed for not less than a predetermined period of time, for example, not less than one month, or not (S507). The predetermined period of time may be arbitrarily set by a user. When the record has been unaccessed for not less than a predetermined period of time (S507: YES), this record is deleted (S508). Then, the controller 30 sets a next record to be an object of the second processing (S509), and the processing returns to S506. When the record has been accessed within a predetermined period of time (S507: NO), the processing proceeds to S509 with skipping the step S508, that is, without deleting the record.

When the second processing has been performed on all records (S506: YES), the controller 30 end the processing shown in FIG. 17.

In this way, the face image database 6a is arranged by deleting a record in which credit data are 0 and a record in which credit data are not 0 but which has been unaccessed for a predetermined period of time.

As thus far described above, according to this embodiment, in the imaging condition setting processing S152 and S401, the game medium lending device 3 and the credit refund device 7 select one of imaging signals based on the reference data, and sets an imaging condition for the CCD camera to an imaging condition corresponding to the imaging signal thus selected. This realizes a highly accurate face authentication even in a place where the surrounding environment rapidly changes, such as a game arcade.

In a case where a credit is reserved and/or read out by use of a card, a player has to carry the card and be careful not to lose it. In such a case, the card may be stolen and abused. Since a device that supports a card use includes a card conveyor, a card reader and the like, a malfunction such as a card jam, a readout error and the like is likely to occur. In this embodiment, however, a card is not used in reserving and/or reading out a credit. In such a case, a player has nothing to carry and therefore does not have to be careful about a loss. Further, a problem of stealing and abusing does not occur. Besides, since the game medium lending device 3 and the credit refund device 7 do not include a card conveyor, a card reader, and the like, a malfunction such as a card jam, a readout error, and the like is unlikely to occur. Therefore, reliability is improved. In addition, a device construction is simplified, and manufacturing costs is reduced. Moreover, using no card makes the game system 1 cheaper.

In the case where a card is used, even if someone stole the card and misused a credit stored in the card, it is difficult to prove it. In this embodiment, however, the controller 30 of the server 5 determines whether there is a possibility of misuse of a credit that is actually possessed by the user, based on memory contents of the face image database 6a and the game medium lending device database 6b (S304). A fraud check is easily made like this, fraud is suppressed.

In a case where an authentication method other than the face authentication is used in combination with the face authentication such as a case where the face authentication is performed under a condition that other information such as account data or ID has been obtained from a card, an object to be checked is narrowed down based on the other information and then a face authentication is performed. In this embodiment, on the other hand, a face authentication is performed without narrowing down an object to be checked. Therefore, an authentication time tends to be relatively long. Accordingly, an authentication time is made shorter by sorting the records included in the face image database 6a in the server 5.

The imaging condition is an angle relative to the reference direction. This enables an imaging condition to be set preferably and in a relatively simple manner.

A face of a person is imaged from both of left and right sides by the game medium lending device 3 and the credit refund device 7, and a pair of left and right imaging signals are generated. This allows a further more accurate face authentication.

The number of times an imaging is performed in the credit reservation processing S107 and the credit readout processing S108 is not limited to one, but may be two or more. For example, it may be possible that face image data based on a first imaging are provisionally registered in the server 5 and the data is formally registered if face image data based on a second imaging agree with the provisionally registered data. This improves security.

In a face authentication, the server 5 determines whether there is a record including face image data that agree with the received face image data in the face image database 6a, or not. That is, the server 5 decides agreement or disagreement with respect to each of face image data in the face image database 6a. However, this is not limitative, and the server 5 may make an intermediate decision between agreement and disagreement. For example, when the server 5 has made an intermediate decision, the server 5 may command the game medium lending device 3 and the credit refund device 7 to retransmit face image data. Alternatively, it may be possible that the server 5 emits a warning sound and in addition the image based on the received face image data and an image based on the face image data stored in the face image database 6a determined as an intermediate between agreement and disagreement are displayed side by side on a monitor of the server 5, in order that a manager of the game arcade determines agreement or disagreement.

Instead of face image data obtained by conversion from an imaging signal, the imaging signal itself may be transmitted from a peripheral device of the gaming machine 2 such as the game medium lending device 3 and the credit refund device 7 when reserving a credit, reading out a credit, and the like. As a result, processing load on the peripheral device is reduced. In this case, the transmitted imaging signal may be converted into face image data by the server 5 or the unit controller 4.

The present invention is also applicable to a game system in which a second reservation of a credit in the server 5 is not permitted. In this case, upon a readout of a credit, a corresponding record may be immediately deleted from the face image database 6a.

In S158 and S257, the game medium lending device 3 may transmit credit data stored inside and face image data at different timings. In this case, either one of the credit data and the face image data may be transmitted first.

After receiving cash from a user and before lending out gaming balls, the game medium lending device 3 may register in the server 5 a credit based on the cash together with face image data of the user.

It may not always be necessary that, in a readout of a credit, a full amount of credit stored in the server 5 is read out. For example, it may be possible that a user specifies an amount to be read out by means of the ten-key pad 17 or the like so that a part of a credit stored in the server 5 is read out.

It may be possible that, upon receiving cash from a user, the game medium lending device 3 does not transmit face image data of the user but transmits credit data based on the cash and ID of the game medium lending device 3 itself, transmits, to the server 5. The server 5 stores therein the credit data based on the cash and the ID of the game medium lending device 3 in association with each other. When a command to reserve a credit is received, the game medium lending device 3 transmits, to the server 5, face image data of a user and consumption data indicating an amount used for a lendout of gaming balls. The server 5 may calculate a current credit of the user by subtracting a consumption amount from the credit based on the cash, and make a new record in the face image database 6a in which credit data thus calculated and the face image data received are stored in association with each other.

When a command to read out a credit is received, the server 5 leaves credit data in the face image database 6a. Then, when a command to reserve a credit is received, the game medium lending device 3 may transmit consumption data to the server 5 which then subtracts a consumption amount from the previously-left credit to thereby calculate a current credit of the user and store it.

It is not always be necessary that an operation guidance, a warning, and the like are announced visually. They may be announced audibly. An announcement of a warning may be made not only by one device but also on a group basis such as by a game unit including the gaming machine 2 and the game medium lending device 3 or by the game unit and the credit refund device 7. For example, each device included in a group may make an announcement based on a lighting pattern using a lighting mechanism.

It may not always be necessary that the CCD camera 29 swings left and right. The CCD camera 29 may swing vertically or rotate. In a case where the CCD camera 29 rotates, an imaging signal may be stored in association with rotation-related information such as an inclination angle.

It may be possible to softwarely perform a zoom processing on the right imaging signal and/or the left imaging signal generated by the CCD cameras 29, 47L and 47R. In such a case, one closest to the reference data may be selected among imaging signals subjected to the zoom processing. In such a case, in addition, the imaging signal may be stored in association with information indicating a zoom ratio.

The imaging condition is not limited to an angle relative to the reference direction. For example, the imaging condition may be a lighting condition and the like.

It is not always be necessary that the game medium lending device 3 and the credit refund device 7 image a face of a person from both of left and right sides. An imaging signal may be generated based on an imaging from a front side for example.

No limitation is put on to which direction a face of a user is oriented. However, the direction may be designated at a time when a preannouncement is given. For example, it may be possible to instruct a user to see a center reel of the gaming machine or the CCD camera window 19 of the game medium lending device.

In the above-described embodiment, data closest to the reference data with respect to a brightness are selected. However, it may be possible to select data closest to the reference data with respect to at least one of a hue, a brightness, and a chroma. In any case, both a monochrome image and a color image can apply.

An imaging signal may be corrected using the reference data 20aL and 20aR, or 40aL and 40aR. This allows a face authentication to be performed further more highly. For example, it may be possible to determine a correction function based on a minimum brightness and a maximum brightness extracted from area data and a minimum brightness and a maximum brightness included in the reference data, and then to correct an imaging signal in accordance with the correction function.

When reserving a credit and reading out a credit, not only a face authentication but also another authentication method may be used in combination with the face authentication. As another authentication method, a method requiring nothing to carry, for example, a method using a password input, is preferable. In a case where another authentication method is used in combination with the face authentication, an object to be checked is narrowed down. Accordingly, an authentication time is made shorter.

The game medium lending device 3 and the credit refund device 7 may support a card use, and may read out a credit and write a credit from and into a card. In this case, by use of a ten-key pad or the like, a user may be able to select to reserve credit data in the server 5 or to write credit data into the card, and also able to select to read out credit data from the server 5 or to read out credit data from the card. Since the credit can be reserved in the server 5 or read out from the server 5, opportunities of using the card are reduced. Therefore, the same effects as in the above-described embodiment are obtained. That is, since a malfunction such as a card jam, a readout error and the like is unlikely to occur, reliability is improved.

A method of communication between the game medium lending device 3 and the credit refund device 7, and the server 5 is not limited to a polling method. For example, the game medium lending device 3 and the credit refund device 7 may request a right of transmission from the server 5, and obtain the right of transmission from the server 5 after the server arbitrates the contention.

It may not always be necessary that the reference data were set when a peripheral device was placed and then the reference data are maintained. For example, a peripheral device may autonomously update the reference data, for example in a regular processing. In such a case, a predetermined area of the image based on the imaging signal, which corresponds to pre-update reference data, is captured, and data corresponding to the area are set as new reference data.

In the above-described embodiment, a face authentication is not performed when lending out gaming balls in S105. However, a face authentication may be performed in S105, and a lendout may be permitted only when face image data registered in the face image database 6a and face image data obtained by imaging that is performed when a lendout is commanded.

Data transmitted from the game medium lending device 3 to the server 5 in S158 or S257, data transmitted from the credit refund device 7 to the server 5 in S405, and the like, may be encoded.

The gaming machine is not limited to a pachinko gaming machine, and may be a pachi-slot machine, a slot machine, and the like.

Depending on a kind of a gaming machine, the game medium lending device may lend out various game media other than gaming balls, for example, game coins.

In the above-described embodiment, the game medium lending device does not have a gaming ball discharger but commands a gaming ball discharger, which is included in a corresponding gaming machine, to discharge gaming balls. However, the game medium lending device may have a gaming ball discharger.

The game medium lending device 3 and the credit refund device 7 perform an existing three-dimensional image measurement by use of its CCD camera 29 and the left-side CCD camera 29 and by use of its CCD cameras 47L and 47R, respectively. As a result, a more accurate image processing is realized. Here, the three-dimensional image measurement is a technique for identifying a shape or a three-dimensional position of a solid material based on an image. The three-dimensional image measurement can be performed by means of various methods such as a method using image data obtained from two cameras and triangulation.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A peripheral device of a gaming machine, comprising:
an imaging unit that images a human face and generates an imaging signal;
a memory that stores therein a reference data item and a plurality of imaging signals, the reference data item relating to at least one of a hue, a brightness, and a chroma of a predetermined area of an image that is based on the imaging signal generated by the imaging unit, the imaging signals generated by the imaging unit under a plurality of different imaging conditions; and
a processor that operates to select, among the imaging signals stored in the memory, such an imaging signal that a data item about an image based thereon is closest to the reference data item with respect to at least one of a hue, a brightness, and a chroma of the predetermined area of the image, and to set a condition for an imaging by the imaging unit to an imaging condition corresponding to the imaging signal thus selected.

2. The peripheral device according to claim 1, wherein the imaging condition is an angle relative to a reference direction.

3. The peripheral device according to claim 1, wherein the imaging unit images a human face from both of left and right sides, and generates a pair of left and right imaging signals.

4. The peripheral device according to claim 1, wherein:
the peripheral device is a first peripheral device that is provided in association with one gaming machine and connected to a server; and
the processor further operates to receive cash, to increase a credit stored inside by an amount of the cash received, to discharge a game medium in accordance with the credit when a lendout command is received, and to transmit, to the server, either one of the imaging signal generated by an imaging performed by the imaging unit under an imaging condition thus set, and a data item obtained by conversion from the imaging signal when either one of a command to reserve a credit in the server and a command to read out a credit stored in the server is received.

5. The peripheral device according to claim 4, wherein the processor operates to transmit, to the server, a data item obtained by conversion from the imaging signal when either one of a command to reserve a credit in the server and a command to read out a credit stored in the server is received.

6. The peripheral device according to claim 1, wherein:
the peripheral device is a second peripheral device that is provided in association with at least one gaming machine and connected to a server; and
the processor further operates to transmit, to the server, when a command to refund a credit is received, either one of the imaging signal generated by an imaging performed by the imaging unit under an imaging condition thus set, and a data item obtained by conversion from the imaging signal, and to discharge cash that is equivalent to a credit received from the server when a notification of refundability is received from the server.

7. The peripheral device according to claim 6, wherein the processor operates to transmit, to the server, when a command to refund a credit is received, a data item obtained by conversion from the imaging signal.

8. A server connected to a peripheral device of a gaming machine, wherein the peripheral device has:
an imaging unit that images a human face and generates an imaging signal;
a first memory that stores therein a reference data item and a plurality of imaging signals, the reference data item relating to at least one of a hue, a brightness, and a chroma of a predetermined area of an image that is based on the imaging signal generated by the imaging unit, the imaging signals generated by the imaging unit under a plurality of different imaging conditions; and
a first processor that operates to select, among the imaging signals stored in the first memory, such an imaging signal that a data item about an image based thereon is closest to the reference data item with respect to at least one of a hue, a brightness, and a chroma of the predetermined area of the image, and to set a condition for an imaging by the imaging unit to an imaging condition corresponding to the imaging signal thus selected,
and wherein the server comprises:
a second processor that operates to receive, from the peripheral device, either one of an imaging signal generated by the imager and a data item obtained by conversion from the imaging signal; and
a second memory that stores therein either one of the signal and the data item received by the second processor,
the second processor further operating to perform an authentication based on whether one that agrees with either one of the signal and the data item thus received is stored in the second memory or not.

9. The server according to claim 8, wherein data items in the second memory are sorted.

10. A game system comprising a peripheral device of a gaming machine and a server connected to the peripheral device,
wherein the peripheral device has:
an imaging unit that images a human face and generates an imaging signal;
a first memory that stores therein a reference data item and a plurality of imaging signals, the reference data item relating to at least one of a hue, a brightness, and a chroma of a predetermined area of an image that is based on the imaging signal generated by the imaging unit, the imaging signals generated by the imaging unit under a plurality of different imaging conditions; and
a first processor that operates to select, among the imaging signals stored in the first memory, such an imaging signal that a data item about an image based thereon is closest to the reference data item with respect to at least one of a hue, a brightness, and a chroma of the predetermined area of the image, and to set a condition for an imaging by the imaging unit to an imaging condition corresponding to the imaging signal thus selected,
and wherein the server has:
a second processor that operates to receive, from the peripheral device, either one of an imaging signal generated by the imaging unit and a data item obtained by conversion from the imaging signal; and
a second memory that stores therein either one of the signal and the data item received by the second processor,
the second processor further operating to perform an authentication based on whether one that agrees with either one of the signal and the data item thus received is stored in the second memory or not.

11. The game system according to claim 10, wherein the imaging condition is an angle relative to a reference direction.

12. The game system according to claim 10, wherein the imaging unit images a human face from both of left and right sides, and generates a pair of left and right imaging signals.

13. The game system according to claim 10, wherein:
the peripheral device is a first peripheral device that is provided in association with one gaming machine; and
the first processor of the first peripheral device further operates to receive cash, to increase a credit stored inside by an amount of the cash received, to discharge a game medium in accordance with the credit when a lendout command is received, and to transmit, to the server, either one of the imaging signal generated by an imaging performed by the imaging unit thereof under an imaging condition thus set, and a data item obtained by conversion from the imaging signal when either one of a command to reserve a credit in the server and a command to read out a credit stored in the server is received.

14. The game system according to claim 10, wherein:
the peripheral device is a second peripheral device that is provided in association with at least one gaming machine; and
the first processor of the second peripheral device further operates to transmit, to the server, when a command to refund a credit is received, either one of the imaging signal generated by an imaging performed by the imaging unit thereof under an imaging condition thus set, and a data item obtained by conversion from the imaging signal, and to discharge cash that is equivalent to a credit received from the server when a notification of refundability is received from the server.

15. The game system according to claim 10, wherein:
the peripheral device includes a first peripheral device and a second peripheral device;
the first peripheral device is provided in association with one gaming machine;
the first processor of the first peripheral device further operates to receive cash, to increase a credit stored inside by an amount of the cash received, to discharge a game medium in accordance with the credit when a lendout command is received, and to transmit, to the server, either one of the imaging signal generated by an imaging performed by the imaging unit thereof under an imaging condition thus set, and a data item obtained by conversion from the imaging signal when either one of a command to reserve a credit in the server and a command to read out a credit stored in the server is received;
the second peripheral device is provided in association with at least one gaming machine; and
the first processor of the second peripheral device further operates to transmit, to the server, when a command to refund a credit is received, either one of the imaging signal generated by an imaging performed by the imaging unit thereof under an imaging condition thus set, and a data item obtained by conversion from the imaging signal, and to discharge cash that is equivalent to a credit received from the server when a notification of refundability is received from the server.

16. The game system according to claim 10, wherein data items in the second memory are sorted.
